(19) United States
(12) Patent Application Publication
(10) Pub. No.: US 2023/0358241 A1
(43) Pub. Date: Nov. 9, 2023

(54) SYSTEMS AND METHODS FOR DRIVE COUPLINGS FOR COMPRESSORS

(71) Applicant: Clark Equipment Company, West Fargo, ND (US)

(72) Inventors: Richard L. Kouzel, Mooresville, NC (US); Brandon Ahrens, Greensboro, NC (US); Jacob Morrison, Cleveland, NC (US); Robert Edwards, Mt. Airy, NC (US); Shane Dyson, Mocksville, NC (US); Branden Baisley, Statesville, NC (US)

(21) Appl. No.: 18/313,083

(22) Filed: May 5, 2023

Related U.S. Application Data
(60) Provisional application No. 63/338,730, filed on May 5, 2022.

(51) Int. Cl. F04D 25/02; F04D 27/00

(52) U.S. Cl. CPC F04D 25/02; F04D 27/004

(57) ABSTRACT

A coupling device can be disposed between a power source and a compressor to selectively couple the power source to the compressor. A control device can be configured to selectively move the coupling device between a disengaged configuration, wherein the power source is decoupled from the compressor, and an engaged configuration, wherein the power source is coupled to the compressor via the coupling device.

### CROSS-REFERENCE TO RELATED APPLICATIONS

This application claims priority to and incorporates by reference U.S. provisional patent application no. 63/338,730, filed May 5, 2022.

### BACKGROUND

The present disclosure relates to rotating machines. More particularly, the disclosure relates to compressor systems (e.g., air compressor systems) that are operably powered by a power source (e.g., an internal combustion engine) to provide pressurized fluid flow.

Conventional rotating machines, for example, air compressors and pumps, typically use a power source that is directly coupled to a driven component. For example, an air compressor system can include a power source with an output shaft that is directly coupled to an input shaft of a compressor (e.g., by a flexible coupling) so that the output shaft and the input shaft rotate together to power the compressor and thereby compress air.

The discussion above is merely provided for general background information and is not intended to be used as an aid in determining the scope of the claimed subject matter.

### SUMMARY

Embodiments of the invention, as generally disclosed herein, can relate to compressor systems (e.g., air compressor systems) and methods for selectively coupling a power source to a compressor. In some cases, a compressor system can include a coupling device that is disposed between a power source and a compressor to selectively couple the power source to the compressor. The coupling device can be operated by a controller based on one or more operational parameters of the compressor system, for example, to provide a soft-start engagement of the power source with the compressor.

According to some aspects of the disclosure, a compressor system can include a power source, a compressor, a coupling device, and a control device. The coupling device can be disposed between the power source and the compressor to selectively couple the power source to the compressor. The control device can be configured to move the coupling device between a disengaged configuration and an engaged configuration. In the disengaged configuration, the power source can be decoupled from the compressor. In the engaged configuration, the power source can be coupled to the compressor via the coupling device.

According to some aspects of the disclosure, a method of operating a compressor system can include, with one or more electronic control devices, decreasing a speed of a power source from a first speed to a second speed when a coupling device is in a disengaged configuration that decouples the power source from a compressor. Additionally, the method can include, with the one or more electronic control devices, increasing the speed of the power source from the second speed to a third speed and moving a coupling device from the disengaged configuration to an engaged configuration to couple the power source to the compressor, as the speed of the power source increases from the second speed, so that an output shaft of the power source rotates an input shaft of the compressor.

According to some aspects of the disclosure, a method of starting a compressor system can include, with one or more electronic control devices, increasing a speed of a power source from a first speed to a second speed when a coupling device is in a disengaged configuration that decouples the power source from a compressor. Additionally, the method can include, with the one or more electronic control devices, controlling the coupling device to move to an engaged configuration after the power source reaches the second speed, to couple the power source to the compressor so that the power source provides operational power to the compressor. Further, the method can include, with the one or more control devices and after the coupling device reaches the engaged configuration, decreasing the speed of the power source from the second speed to a third speed.

According to some aspects of the disclosure, a method of operating a compressor system can include, controlling the compressor system with the one or more electronic control devices to operate in a disengaged mode. A coupling device can be controlled to move from an engaged configuration to a disengaged configuration to decouple a power source from a compressor of the compressor system. A first valve can be closed to block flow of oil to rotors of the compressor. A speed of the power source can be reduced. A pressure can be reduced for a tank that is fluidly coupled to the rotors to receive pressurized air from the rotors.

According to some aspects of the disclosure, a method of starting a compressor system can include, with one or more electronic control devices, operating a power source at a startup speed. Additionally, the method can include, with the one or more electronic control devices, receiving an indication that a temperature of the power source satisfies a temperature criterion. Further, the method can include, in response to receiving the indication, controlling the coupling device to move to an engaged configuration, to couple the power source to the compressor so that the power source provides operational power to the compressor.

According to some aspects of the disclosure, a method of starting a compressor system in a start-up sequence can include, with one or more electronic control devices and with a power source at a first rotational speed, controlling a coupling device to operationally couple the power source to a compressor. With the coupling device operationally coupled to the power source, a rotational speed of the power source can be increased from the first rotational speed to a second rotational speed to cause powered rotation of the compressor. With the compressor in powered rotation: the coupling device can be controlled to decouple the power source from the compressor; and the rotational speed of the power source can be further increased toward an operational speed.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a schematic view of a compressor system having power source coupled to a compressor with a coupling device, according to aspects of the disclosure;

FIG. 2 is a flowchart of a method of operating a compressor system having power source coupled to a compressor with a coupling device, according to aspects of the disclosure;

FIG. 3 is a plot illustrating a soft-start function of a compressor system having a clutch with independent soft-engagement functionality, according to aspects of the disclosure;

FIG. 4 is a plot illustrating another soft-start function of a compressor system having a clutch with independent soft-engagement functionality, according to aspects of the disclosure;

FIG. 5 is a plot illustrating a soft-start function of a compressor system having a clutch without independent soft-engagement functionality, according to aspects of the disclosure;

FIG. 6 is a flowchart of a method of operating a compressor system having power source coupled to a compressor with a coupling device, according to aspects of the disclosure;

FIG. 7 is a plot illustrating another soft-start function of a compressor system having a clutch, according to aspects of the disclosure;

FIG. 8 is a flowchart of a method of operating a compressor system having power source coupled to a compressor with a coupling device, according to aspects of the disclosure;

FIG. 9 is a plot illustrating another soft-start function of a compressor system having a clutch, according to aspects of the disclosure;

FIG. 10 is a flowchart of a method of operating a compressor system having power source coupled to a compressor with a coupling device, according to aspects of the disclosure;

FIG. 11 is a plot illustrating a priming sequence of a compressor system having a clutch, according to aspects of the disclosure;

FIG. 12 is a flowchart of a method of operating a compressor system having power source coupled to a compressor with a coupling device, according to aspects of the disclosure;

FIG. 13 is a plot illustrating a soft-start function of a compressor system having a clutch with independent soft-engagement functionality, according to aspects of the disclosure.

### DETAILED DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Further, unless otherwise specified or limited, the terms “about” and “approximately” as used herein with respect to a reference value refer to variations from the reference value of ±5%, inclusive. Similarly, the term “substantially” as used herein with respect to a reference value refers to variations from the reference value of within ±30%, inclusive. Further in this regard, “substantially lower” and “substantially higher” indicate a value that is, respectively, lower and higher than a reference value by more than 30% of the reference value. Unless otherwise noted, ranges as listed herein are inclusive of endpoints of the range.

Also as used herein, unless otherwise specified or limited, “speed” refers to a rotational speed of a rotating body, as can be measured in revolutions per minute (RPM). In particular, a “speed” of an engine refers to the rotational speed of a drive shaft of the engine, as in some cases may also equal the rotational speed of one or more output shafts of the engine.

As noted above, many conventional compressor systems include a direct coupling between an input shaft of an air compressor and an output shaft of an engine. However, consequentially, the air compressor is driven by any rotation of the power source and thus presents a potentially substantial load on the power source at all times. As one result of this arrangement, conventional air compressors generally require robust starting systems that can rotate the power source (e.g., an internal combustion engine) and the compressor during a startup sequence (i.e., a sequence of control operations that starts powered rotation of an engine, from zero RPM to a non-zero speed). To overcome peak inertial forces of the air compressor system during a startup sequence, particularly in cold environments, power sources for air compressors are typically oversized relative to expected steady operational loads. This can lead to increased fuel consumption and extra cost for a power source that is oversized for almost all conditions (i.e., except for when the engine is being started). Additionally, because the compressor is always coupled to the power source, the system is always under load to compress air, even when compressed air is not being demanded (e.g., during startup, when a storage tank is full, or during pauses in work operations). As similarly noted above, this can result in poor engine performance and increased fuel consumption. Further, although some power sources can be operated at lower speeds to partially address the issues noted above, this can result in greater condensation build-up within compressor systems, with corresponding potential for maintenance or for sub-optimal performance.

Some embodiments of the disclosed technology can provide improved configurations for rotational machinery, and particularly for air compressors, including with systems and methods for selectively decoupling the rotational machinery from a power source. For example, by selectively decoupling the compressor from the power source, the load on the power source created by the compressor can be eliminated, resulting in easier startup. Correspondingly, because the inertial load of the compressor can be selectively removed from the power source, a smaller (e.g., more fuel-efficient) power source can be used to operate a given compressor, as compared to with conventional arrangements.

Aspects of the present disclosure provide for a compressor system that includes a coupling device disposed between a power source and a compressor to selectively couple the power source to the compressor. For example, a clutch system (e.g., an electromagnetic clutch system of various known configurations) can be interposed between an output shaft of an engine (or other rotational power source) and an input shaft of a compressor. The coupling device (e.g., the clutch system) can be controlled to selectively move between a disengaged configuration and an engaged configuration during operation of the engine and the compressor.

Generally, in a disengaged configuration, a coupling device operatively decouples a power source from a compressor so that, for example, a power source output shaft and a compressor input shaft can rotate independently of one another. That is, when the coupling device is in the disengaged configuration the power source can operate without an operational load from the compressor (e.g., so that the output shaft rotates while the input shaft does not). Generally, in an engaged position, a coupling device operatively couples the power source to the compressor so that, for example, the power source is exposed to the full inertial load of the compressor and the output shaft can operationally power the input shaft (e.g., to provide compressed service air). Thus, the compressor acts as a load on the power source when the coupling device is in the engaged configuration (e.g., so that rotation of the output shaft and the input shaft rotate at the same speed). Additionally, in some cases, a compressor may further include a control device (e.g., industrial electronic controllers or general purpose programmable computers) that can be configured to operate the coupling device to move the coupling device between the disengaged configuration and the engaged configuration with particular timing or based on other criteria.

More specifically, in some cases, the coupling device can be configured as a clutch that includes a drive member (e.g., a clutch or friction plate) that is coupled to and configured to rotate with an output shaft of a power source (e.g., via a direct connection or an indirect connection, for example, a gear train). Additionally, the clutch can include a driven member (e.g., a pressure plate) that is coupled to and configured to rotate with an input shaft of a compressor (e.g., via a direct connection or an indirect connection, for example, a gear train). The drive member and the driven member are moveable relative to one another (e.g., in response to a signal from a controller) to allow the clutch to move between an engaged configuration, wherein the drive member and the driven member are spaced apart from one another, and an engaged configuration, wherein the drive member and the driven member are in (frictional) contact with one another. For example, the driven member can be moved toward or away from the drive member (e.g., along a rotational axis of the input shaft) based on electronic control commands from an electronic control device. Because the drive member rotates with the output shaft, the friction between the drive member and the driven member causes the driven member to rotate with the drive member and, thus, the power source is operatively coupled with the compressor.

Some embodiments of the disclosed technology can allow for a soft-start or soft-engagement of an engine with a compressor, via a coupling device, to reduce undesirable loads (e.g., inertial loads) on the power source during startup or other operations. For example, while maintaining a coupling device in a disengaged state, a controller can be configured to reduce a rotational speed of a power source from a first rotational speed to a second rotational speed (e.g., reduce speed from a warm-up or high-idle speed to a low-idle speed or below a low idle speed, for example, a minimum engine speed). Once the power source speed (e.g., as measured at an output shaft) reaches the second rotational speed (e.g., after a predetermined time from when the first engine signal was sent), the controller can increase the rotational speed of the output shaft from the second rotational speed to a third rotational speed (e.g., a high-idle or run speed). The first rotational speed and the third rotational speed may be the same, in some cases, or they may be different (e.g., with the third speed higher than the second speed). RPM ranges corresponding to engine run state, for example, a low-idle state or operational state, can vary depending on the specific application, engine size, fuel type, and other engine parameters, manufacturer settings, or operational conditions. For example, in some cases, a minimum engine speed can be less than 1000 RPM (e.g., between 500 RPM and 900 RPM), a low-idle speed can be between 1200 RPM and 1700 RPM, and an operational speed can be between 1800 RPM and 2800 RPM. In some cases, a low-idle speed can be between 500 RPM and 900 RPM, or less than or equal to 1000 RPM. In some cases, a high-idle speed can be between 1500 RPM and 2100 RPM. In other cases, RPM ranges corresponding to a warm-up or high-idle speed, a low-idle speed, or an operational speed can be different.

A controller can sometimes operate a coupling device to reach an engaged configuration for full operational delivery of power as the speed of the power source is increasing from the second (e.g., reduced) speed but before the speed of the power source reaches the third (e.g., operational) speed. In some cases, this may include commanding the coupling device to move to the engaged configuration while the speed of the power source is at the second speed (or otherwise before an increase from the second speed commences). For example, an electronic control system may command a clutch to an engaged configuration before the control system commands an engine to increase from a reduced (e.g., second) speed. As a result, in some cases, the clutch may operate to finally reach the engaged configuration before the engine speed has increased substantially above the reduced speed. Thus, with appropriate command timings, some embodiments can operate compressor systems to ensure optimal engine speeds for initial clutch engagement while also avoiding excessive drop in engine speed during compressor startup (e.g., to below a stall-free or other optimal speed), due to the initial increase in inertial load from the compressor. In some cases, an engagement signal may be provided at a predetermined time so that a coupling device engages a power source to a compressor when power source speed is at or above a minimum engagement speed. In some cases, the time at which an engagement signal is sent may be based on whether a clutch includes an independent soft-engagement functionality (e.g., some clutches can be configured to provide a progressive clutch engagement profile that controls the relative movement between a drive member and a driven member to gradually increase torque transfer therebetween).

In some embodiments, to further reduce initial loading on a power source, a control system can delay the opening of an inlet valve (e.g., an unloader valve) of the air compressor until after a coupling device between the power source and compressor is in the engaged configuration, and in some cases also until after the power source reaches a third (e.g., operational) rotational speed. For example, a controller can be configured to provide a valve open signal to the compressor at a predetermined time after the engagement signal, or at a predetermined rotational speed power source moves from a second (e.g., minimum commanded) rotational speed to the third (e.g., operational) rotational speed.

Various other control approaches can also be applied in some embodiments. For example, as further detailed below, some approaches can include increasing an engine speed before clutch engagement, controlling clutch engagement based on coolant temperature, of controlling clutch engagement to help remove waxy oil from within a compressor.

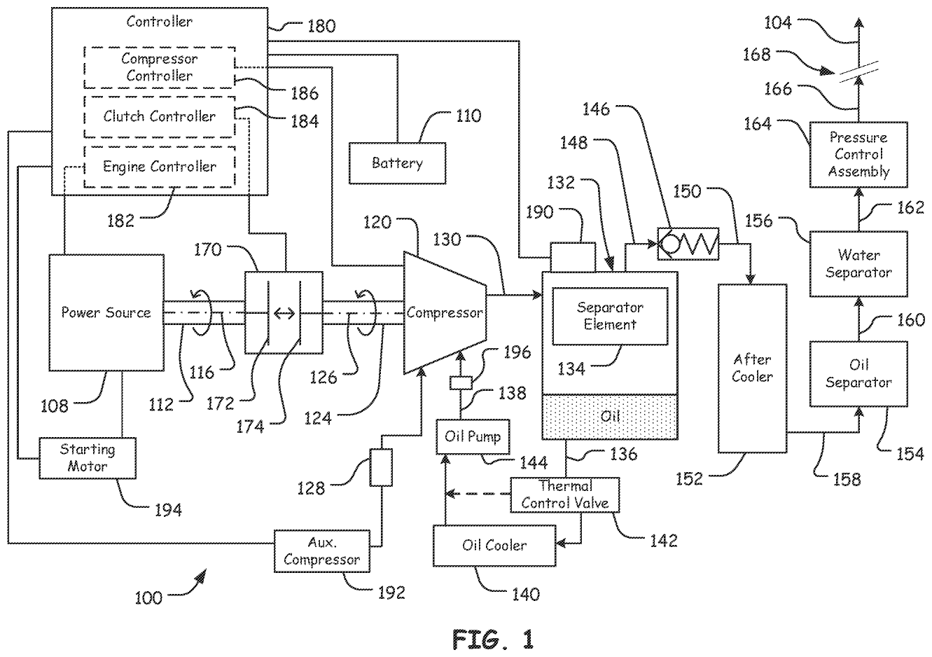

The concepts described herein can be practiced on a variety of different types of rotating machinery. A representative rotating machine system on which aspects of the disclosure can be practiced is illustrated in FIG. 1. For the sake of brevity, only one rotating machine system is illustrated and discussed as being a representative rotating machine system. However, as mentioned above, the embodiments described below can be practiced on any of a number of rotating machines, including air compressors, pumps, and the like.

FIG. 1 is a schematic illustration of the representative rotating machine configured as a compressor system 100, which can be configured to generate and discharge an air flow or another compressed gas (e.g., a refrigerant). The compressor system 100 generally includes a power source that is configured to provide power (e.g., rotational power) to a driven component. In the illustrated embodiment, the compressor system 100 is configured as an air compressor system (e.g., a single-stage air compressor system) that is configured to take in and pressurize atmospheric air to provide a pressurized air flow to a job site, via a supply line 104 (e.g., a service line). In other embodiments, a compressor system can be a multi-stage compressor system. In some cases, the compressor system 100 can be configured as a portable compressor system that can be moved between various job sites, or as a stationary (e.g., permanent) compressor system.

To compress atmospheric air and provide an air flow at the supply line 104, the compressor system 100 includes a power source configured as an engine 108 (e.g., a diesel engine or another type of internal combustion engine), although other types of power sources can also be used. The engine 108 includes and is configured to rotate an output shaft 112, for example, a crankshaft or flywheel, about a first rotational axis 116. The output shaft 112 can be configured to provide (rotational) power to a driven device, namely, a compressor 120 (e.g., dry or oil-flooded compressor) that is configured to pressurize air and discharge an air flow. More specifically, the output shaft 112 can be coupled to an input shaft 124 of the compressor 120 that is configured to rotate about a second rotational axis 126 (e.g., coaxial with the first rotational axis 116). Accordingly, the engine 108 can be operatively coupled to the compressor 120 so that the engine 108 powers the compressor 120.

With continued reference to FIG. 1, the compressor 120 can be configured as an oil-flooded screw compressor, in which oil flows around and between two counter-rotating screws to lubricate and improve sealing between components as the changing size of cells between the screws compresses air. For example, atmospheric air can be drawn into the compressor 120 at an air inlet valve 128, to be compressed by the rotation of the screws, and then discharged from the compressor 120 as a high pressure flow at a compressor outlet 130. In some cases, the air inlet valve 128 can be an electronically controlled valve that can be powered by, for example, a battery 110 of the compressor system 100, or it can be a mechanically-actuated valve, for example, a spring-biased butterfly valve.

During operation of the compressor 120, some of the oil may mix with the air and be carried through the compressor outlet 130. However, it is generally undesirable to provide operators with an air flow that contains oil. Accordingly, for example, compressed air from the compressor 120 can pass through the compressor outlet 130 to a separator tank 132 configured to separate oil from the pressurized air with a separator element (e.g., a filter or other mechanical separation element with structures to guide fluid flow or otherwise capture entrained oil droplets). Oil that is removed from the air by the separator element 134 can be drained (e.g., to an oil sump) at the bottom of the separator tank 132, while the pressurized air remains above the oil in the separator tank 132 to be provided for service on demand.

In some cases, oil that is removed from the air-oil mixture in the separator tank 132, can then be re-used to lubricate the compressor 120. In particular, the separator tank 132 can include an oil outlet 136 that allows oil from the oil sump to flow back into the compressor 120 via an oil inlet 138. In some cases, an oil cooler 140 can be disposed upstream of the oil inlet 138 between the separator tank 132 and the compressor 120 to provide a cooled oil flow to the compressor 120, which can help to cool the compressor 120 and other components of the compressor system 100 by removing at least some of the heat generated by compression of air within the compressor 120. In such cases, a thermal control valve 142 can be disposed upstream of the oil inlet 138 between the separator tank 132 and the compressor 120, and can be configured to selectively direct flow of oil from the oil sump to the oil cooler 140 (as indicated by the solid line in FIG. 1) or to the compressor 120, by bypassing the oil cooler 140 (as indicated by the dashed line in FIG. 1). In such cases, the thermal control valve 142 can be mechanically operated (e.g., a slide valve having a wax plug) or electronically controlled to selectively direct flow to the oil inlet 138. In some cases, the pressure of the air within the separator tank 132 can drive the oil flow along the return path to the compressor 120. In some cases, an oil pump (not shown) can be provided. Further, in some cases, an oil pump 144 can be disposed upstream of the oil inlet 138 between the separator tank 132 and the compressor 120 to provide increased circulation of oil to and within the compressor 120, which can provide increased lubrication, cooling, and sealing for components of the compressor 120. In such cases, the oil pump 144 can be powered directly by the engine 108, by rotation of the compressor 120, or by an external power source (not shown)

In some embodiments, a separator tank can also serve as a storage tank that can store pressurized air from a compressor for use when needed at a supply line. In this regard, the separator tank 132 can serve as a buffer that stores a pressurized volume of air and thereby allows the compressor system 100 to provide air flow at flow rates that are greater than those that can be provided by the compressor 120 alone. Thus, in some cases, the air within the separator tank 132 may be held at a pressure that is higher than a pressure supplied at the supply line 104. To maintain pressure within the separator tank 132, the compressor system 100 can include a minimum pressure valve 146 that is coupled to an air outlet 148 of the separator tank 132. For example, the minimum pressure valve 146 can be configured as a normally closed, spring biased check valve that only opens when the pressure of the air passing through the air outlet 148 is large enough to overcome the force of the spring or other biasing element. In some cases, the minimum pressure valve 146 can be an adjustable pressure valve. Additionally, the minimum pressure valve 146 can also inhibit or prevent air or other material from reversing its flow direction and entering the separator tank 132, oil cooler 140, and compressor 120 from the downstream (e.g., the supply line 104) side of the system. In other embodiments, the minimum pressure valve 146 can be provided along other points on the flow path between the separator tank 132 and the supply line 104).

In some cases, a compressor system can include additional components disposed between the compressor and a supply line to remove additional contaminants (e.g., water and oil) from the air flow. For example, as illustrated in FIG. 1, the compressor system 100 includes an aftercooler 152 that is coupled with an outlet 150 of the minimum pressure valve 146. The aftercooler 152 is a heat exchanger that cools the air to remove heat produced during compression. Consequently, as the air cools within the aftercooler 152, the air approaches its dew point, which can cause moisture to condense out of the air. Additionally, the compressor system 100 can also include an oil separator 154 (e.g., a filter) and a water separator 156 to further remove oil and water from the service air flow. As illustrated in FIG. 1, service air can flow from an outlet 158 of the aftercooler 152 to the oil separator 154 and then from an outlet 160 of the oil separator 154 to the water separator 156. In other embodiments, the aftercooler 152, the oil separator 154, and the water separator 156 can be arranged differently, or in other combinations.

Prior to exiting the compressor system 100 at the supply line 104, the air can pass from an outlet 162 of the water separator 156 and through a pressure control assembly 164. The pressure control assembly 164 can be configured to control a pressure of the air flow that is provided to the supply line 104 (e.g., a supply pressure of the compressor system 100) at a connection point 166 (e.g., a hose connector or other structure). Accordingly, pressurized air from the compressor system 100 can pass from the compressor 120 to the supply line 104, via an outlet 168 of the pressure control assembly 164, when the supply line 104 is coupled to the connection point 166. The pressure control assembly 164 may be an adjustable pressure control assembly that can be manipulated by a user to supply a desired air pressure at the supply line 104.

In some cases, it can be beneficial to reduce a flow rate of compressed air or stop the compression of air altogether. For example, it may be advantageous to reduce a flow rate of compressed air when air flow is not required at the supply line 104 or at other times. However, operating a compressor at reduced speed can result in lower compressor temperatures, which can in turn cause increased condensation within the compressor 120 and other components that are downstream of the compressor 120. For example, condensation can accumulate within the separator tank 132, where it can mix with the oil in the sump, thereby reducing oil life, increasing the risk of rust formation and other corrosion, and increasing maintenance costs.

Relatedly, where a compressed air flow is not needed, some systems can be configured to close an inlet valve of a compressor to stop inflow of air to the compressor and thus reduce a load on a power source. For example, when an air flow is not required at the supply line 104 and the separator tank 132 is at a maximum pressure, the air inlet valve 128 can be configured to close to prevent the compressor 120 from taking in additional air from the atmosphere. As a result, a vacuum can be created within the compressor 120, which can reduce the load on the engine 108, further reducing fuel consumption. However, because the mechanical rotation of the compressor 120 is still powered by the engine 108, there will still be some load on the engine 108.

To further reduce fuel consumption and the rate of condensation within a compressor system, it can be beneficial to decouple a driven component of a compressor from the associated power source. For example, according to some embodiments of the technology disclosed herein, the compressor 120 can be selectively decoupled from the engine 108 so that the inertial load of the compressor 120 is entirely removed from the engine 108. For example, the compressor 120 can be decoupled from the engine 108 when air flow is not needed at the supply line 104, or during engine startup, as can generally allow for the use of a smaller engine than in conventional systems, for similarly sized compressors.

For example, with continued reference to FIG. 1, the compressor system 100 can include a coupling device configured as a clutch 170 that is disposed mechanically between the engine 108 and the compressor 120. In particular, the clutch 170 is coupled to both the engine 108 (e.g., at the output shaft 112) and the compressor 120 (e.g., at the input shaft 124) and is configured to move between a disengaged configuration and an engaged configuration by a controller 180, as is further discussed below. In the disengaged configuration, the output shaft 112 and the input shaft 124 are decoupled from one another so that the engine 108 does not power rotation of the compressor 120 (e.g., torque is not transferred between the output shaft 112 and the input shaft 124, and the shafts 112, 124 can rotate independently of one another). As a result, the inertial load of the compressor 120 can be completely removed from the engine 108, which can be beneficial during engine startup and when a compressed air flow is not needed. In particular, decoupling of the compressor 120 from the engine 108 can reduce peak inertial loading on the engine 108 during startup and can allow for lower engine speeds when the compressor system 100 does not need to provide compressed air without the same potential for accumulation of condensation as in conventional systems.

A clutch can be configured as any of a number of known coupling devices that can selectively couple two rotating bodies together for operational transfer of rotational power. For example, in the illustrated embodiment, the clutch 170 is configured as an electromagnetic friction clutch having a drive member 172 that is configured to selectively couple with and power rotation of a driven member 174. More specifically, in the illustrated embodiment, the drive member 172 is configured as a friction plate that is coupled to the output shaft 112 of the engine 108 (e.g., via a direct coupling or indirect coupling) and the driven member 174 is configured as a pressure plate that is coupled to the input shaft 124 of the compressor 120 (e.g., via a direct or indirect coupling). Accordingly, when the drive and driven members 172, 174 are moved into an engaged configuration, the output shaft 112 can cause the input shaft 124 to rotate, via frictional engagement between the drive member 172 and the driven member 174. In other embodiments, however, other clutch configurations can be used. For example, a clutch can be configured as a radial clutch, wherein a drive member or a driven member move along a radial direction relative to one another to move between the disengaged configuration and the engaged configuration.

In some cases, to provide smoother and more efficient transitions between the disengaged configuration and the engaged configuration, a clutch can include a damper (not shown). For example, an elastomeric bushing, a spring, or other resilient member that acts as a torsional damper can be arranged to provide a cushion as a clutch moves into engagement. In some cases, to reduce wear on a drive member and a driven member, a clutch can further include a lockup mechanism (not shown) that is configured to mechanically lock the drive member and the driven member together so that they rotate together in an engaged configuration, without relying solely on frictional contact. In that regard, a controller (e.g., the controller 180, as also discussed below) can sometimes be configured to control a lockup mechanism.

In some cases, it may be advantageous to place a drive member and a driven member in a partially engaged configuration, wherein the drive member and the driven member are in contact with one another, but the normal force is insufficient to lock the drive member with the driven member so that they rotate in unison. For example, with respect to the illustrated embodiment, while there may be frictional contact between the drive member 172 and the driven member 174 in a partially engaged configuration, the drive member 172 and the driven member 174 can slip past one another so that they are rotating at different speeds (e.g., the drive member 172 may rotate faster than the driven member 174).

A compressor system can further include a controller (e.g., a control device or system) that can be configured to control one or more operational parameters of the compressor system. For example, the controller 180 of the compressor system 100 can be configured to control a rotational speed of the output shaft 112 (e.g., via electronic control of a speed of the engine 108), the engagement and disengagement of the engine 108 with the compressor 120 (e.g., via electronic control of the clutch 170), and the opening and closing of the air inlet valve 128 of the compressor 120 (e.g., via control of an on-off or proportional valve).

The controller 180 can be implemented as one or more known types of processor devices (e.g., microcontrollers, field-programmable gate arrays, programmable logic controllers, logic gates, etc.), including as part of general or special purpose computers. In addition, the controller 180 can also include other generally known computing components, including memory, inputs, output devices, etc. (not shown), as appropriate. Controller 180 can thus be configured to implement some or all of the operations of the control processes described herein, which can, as appropriate, be executed based on instructions or other data retrieved from memory. In some embodiments, the controller 180 can include multiple control devices (or modules) that can be integrated into a single component or arranged as multiple separate components. In some embodiments, the controller 180 can be part of a larger control system and can, accordingly, include or be in electronic communication with a variety of control modules, for example, engine controllers, clutch controllers, compressor controllers, hub controllers, etc. For example, as illustrated in FIG. 1, the controller 180 may include one or more of a dedicated engine controller 182, a dedicated clutch controller 184, a dedicated compressor controller 186, or various other control modules.

Generally, a controller can be configured to control a compressor system in response to a user input, or in response to or otherwise based on one or more operational parameters of the compressor system (e.g., as sensed by various sensors on or around a compressor system or predetermined and stored in memory). Correspondingly, as also discussed above, the controller 180 can operate to monitor or control a speed of the power source 108, to monitor or control the state of the air inlet valve 128, or to monitor or control a state of the clutch 170. For example, the controller 180 can be configured to increase an engine speed to maintain a supply pressure at the supply line 104. Conversely, the controller 180 can reduce an engine speed when a lower air flow is needed to maintain a supply pressure at the supply line 104, such as when no air is flowing from supply line, but the separator tank 132 is not at a maximum pressure (e.g., the compressor system 100 is filling the separator tank 132).

As another example, when starting the engine or when the separator tank 132 is at a maximum pressure and no air is flowing out of the system at the supply line 104, the controller 180 can be configured to move the clutch 170 from the engaged configuration to the disengaged configuration to decouple the engine 108 from the compressor 120, stopping the compressor 120 from providing a compressed air flow. Relatedly, once system pressure is reduced to a minimum system pressure (e.g., a threshold value), or after the engine 108 reaches a minimum operating temperature following startup, the controller 180 can be configured to move the clutch 170 from the disengaged configuration to the engaged configuration so that the engine 108 can power the compressor 120 to provide a compressed air flow.

As yet another example, a controller can be configured to control engagement and disengagement of a clutch to help manage moisture build-up within a compressor system. For example, clutch control can be associated with helping to maintain particular temperatures or pressures for a compressor system and thus avoid issues relating to condensation of moisture (e.g., water) out of the compressed air flow. Accordingly, as illustrated in FIG. 1, the controller 180 can be in communication with a moisture sensor 190 that is configured to sense a water content level relative to the compressed air flow. A moisture sensor can generally be a humidity sensor (can be used to measure the level moisture in the ambient induction air or in the compressed air in the tank), a water contact sensor, or any variety of other known sensor types that are configured to measure water content. In some cases, a sensor signal corresponding to water content for a compressor system can thus be evaluated to control operation of a clutch for a compressor. For example, when operating at idle, upon sensing a predetermined moisture level, the controller 180 can command the clutch 170 to disengage, thereby stopping compressor 120 and preventing additional water vapor from being introduced into the system 100. In other implementations, other criteria for determining clutch commands based on sensed moisture (e.g., internal moisture) can also be employed, as appropriate.

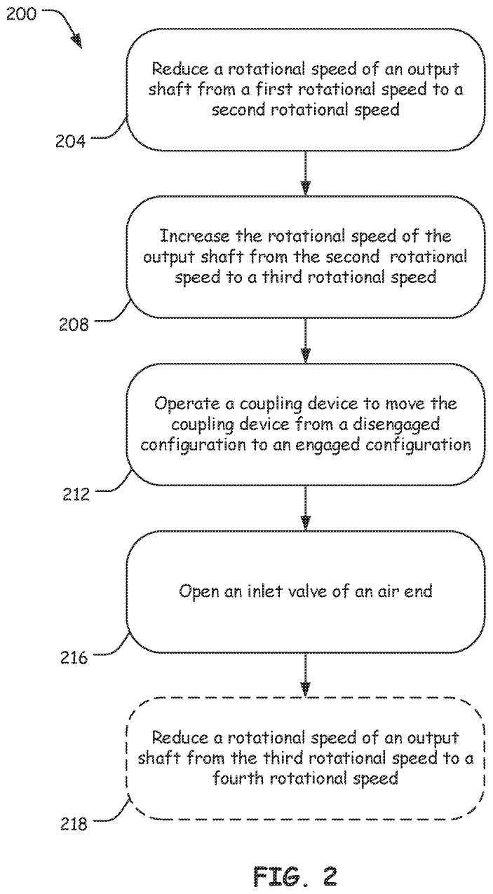

In some cases, a controller can be configured to control a clutch to provide a soft start or other soft engagement for a compressor and a power source. That is, a controller can be configured to modulate engagement of a compressor to a power source during startup of a compressor system or at other times. This approach, for example, can reduce noise, vibration, and harshness during the transition of the system from a disengaged configuration to an engaged configuration, and generally improve system reliability (e.g., by preventing stalls) and efficiency (e.g., via improved fuel economy). As one example, referring to FIG. 2, a method 200 of operating the compressor system 100 to provide a soft-start function when engaging the engine 108 with the compressor 120 is illustrated, according to some aspects of the disclosure. While the method 200 is described with reference to the compressor system 100 discussed above, the method can also be used with other types of rotating machines. Additionally, operations of the method 200 need not be carried out in the specific order discussed below and, in some cases, may be implemented with other control devices and systems not explicitly described herein. Generally, the method 200 can be implemented using a variety of known general purpose control devices (e.g., the controller 180), or can be implemented using special-purpose control devices constructed according to known principles to implement the concepts disclosed herein.

At block 204, the method 200 can include reducing an engine speed from a first engine speed to a second engine speed, to reduce a rotational speed of an output shaft from a first rotational speed to a second rotational speed. Thus, generally, the speed of the engine can be controlled to be a relatively low value before a clutch is engaged. In some cases, the compressor system 100, the engine speed of the engine 108 and the rotational speed of the output shaft 112 may be the same. However, in other cases, they may be different (e.g., an engine speed may be greater or less than a rotational speed of an output shaft), and a speed of the engine may be selected to achieve a desired speed of an output shaft.

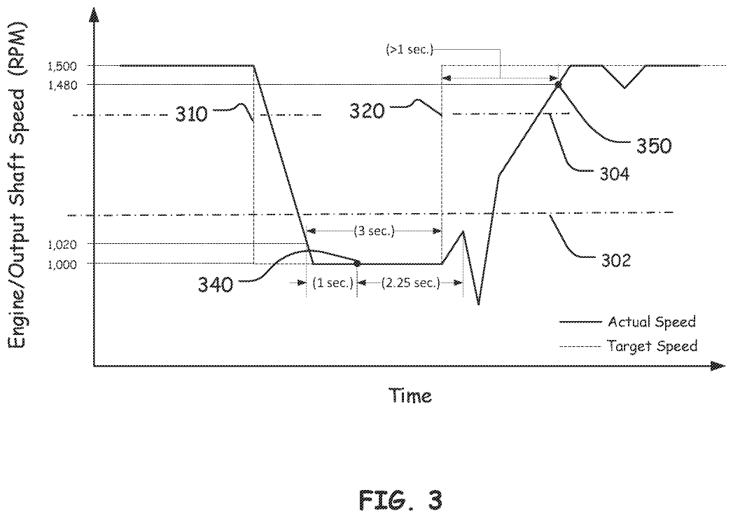

Generally, operations at block 204 can help to bring engine speed to a lower relative value so that engagement with a clutch can be smoother and otherwise more efficient. In some implementations, a first engine speed may be a high-idle speed of the engine, as may be suitable to initially warm up the engine upon start up, and a second engine speed may be a low-idle speed that is substantially lower than the first engine speed. For example, with additional reference to FIGS. 3-5, at the start of the method 200 (i.e., at left in FIGS. 3-5) the engine 108 may be controlled to operate at a first engine speed that is between 1250 RPM and 1750 RPM, or more particularly, approximately 1500 RPM, which may correspond with a high-idle speed of the engine 108. The engine 108 may then receive a first engine speed (change) command signal 310 from the controller 180 (e.g., the engine controller 182) to reduce the engine speed to a lower, second engine speed that is, for example, between 500 RPM and 1,200 RPM.

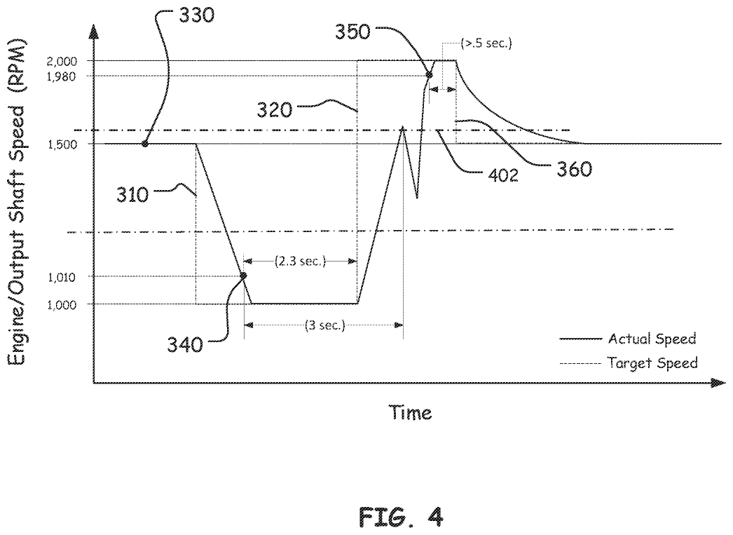

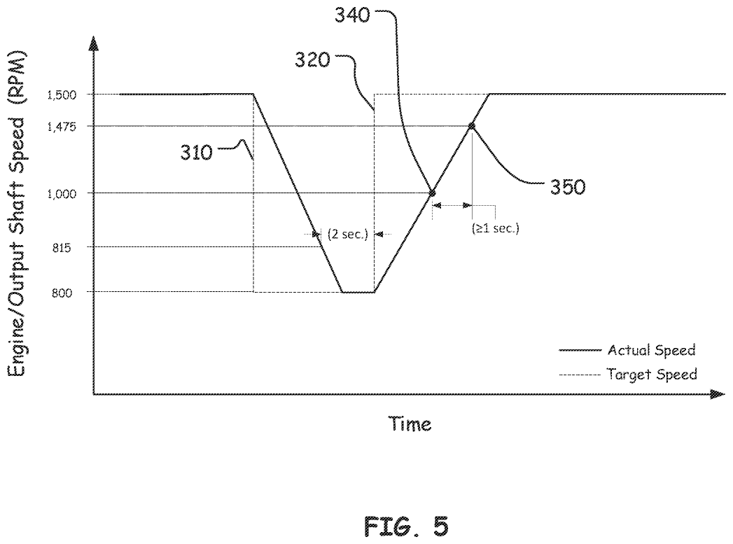

In some cases, a second engine speed may be selected depending on whether or not a clutch is provided with a separate soft-engagement functionality. Generally, a separate soft-engagement functionality of the clutch allows the clutch to gradually engage over an extended time (e.g., 2 to 3 seconds) can be used in combination with controlling a speed of a power source to further reduce noise, vibration, and harshness (e.g., by preventing a drive member and a driven member from immediately locking together, and instead, allowing some slip therebetween prior to lockup). For example, as illustrated in FIGS. 3 and 4, where a clutch (e.g., the clutch 170) is provided with a separate soft-engagement function, the second engine speed may be approximately 1000 RPM. As another example, as illustrated in FIG. 5, where a clutch (e.g., the clutch 170) is not provided with a separate soft-engagement function, the second engine speed may be lower (e.g., as low as the engine will go without stalling), in particular, between 500 RPM and 900 RPM, or approximately 800 RPM. In other embodiments, however, other RPM settings can be used, as appropriate. In this way, for example, where a more abrupt engagement of a clutch with a compressor may be expected, the second engine speed can be lowered to reduce the kinetic energy of the engine output shaft at the time of clutch engagement.

In some implementations, the method 200 can include preventing a clutch from moving from the disengaged configuration to the engaged configuration until the engine 108 has increased to at least a minimum operating temperature (e.g., with a coolant temperature of the engine 108 greater than or equal to 80 degrees Fahrenheit, as indicated at example time 330 in FIG. 4). However, in some cases, a manual override can be provided to allow an operator to move the clutch 170 from the disengaged configuration to the engaged configuration (e.g., via the controller 180), so that an air flow can be provided at the supply line 104 prior to the engine 108 reaching the minimum operating temperature. In some implementations, the method 200 can include not reducing an engine speed from a first speed to a second speed until after the engine 108 has increase to at least minimum operating temperature. In some implementations, an amount of time after initial startup of an engine can be measured as a proxy for operating temperature. In other words, the controller can make a reasonable approximation of the operating temperature (i.e., whether it is above a minimum threshold) based on the length of time that the compressor has been operating. This approximation may, or may not, include information about ambient temperatures. Alternatively, controller can obtain actual temperature information from sensors that are in communication with the controller.

At block 208, the method 200 can include increasing an engine speed from the second engine speed to a third engine speed. In the examples illustrated in FIGS. 3 and 5, the third engine speed is caused by a second engine speed (change) command signal 320, and can be the same as the first engine speed. However, in other embodiments, other command signals can be used or the first and third engine speeds may be different. In some implementations, as illustrated in FIG. 4, a third engine speed may be greater than a first engine speed. For example, a first engine speed may be an idle speed and a third engine speed may be an operational speed or may be higher than an operational speed. As used herein, operational speed indicates a speed of a power source (e.g., engine) operatively coupled to the compressor when the compressor is operating to provide service air in response to operator demand. Thus, in some cases, an engine or other power source may have multiple predetermined (or other) operational speeds, which may be a function of the amount of compressed air demanded by the customer.

In different embodiments, a controller can be configured to command a power source to a third speed depending on various operational parameters. For example, in the illustrated embodiment, the controller 180 can be configured to send a command signal to increase at a predetermined time (e.g., approximately 3 seconds as in FIG. 3, approximately 2.3 seconds as in FIG. 4, or approximately 2 seconds as in FIG. 5) after the speed of the engine 108 reaches a predetermined value. For example, the command signal 320 to operate an engine at an increased (third) speed can be transmitted a predetermined time after engine speed reaches a lower threshold. In some cases, such a threshold may correspond to a speed that is slightly offset from the second engine speed (e.g., at approximately 1020 RPM as in FIG. 3, or approximately 815 RPM as in FIG. 5).

In other embodiments, the second engine speed signal can be sent depending on other parameters or combinations of parameters, including, for example, the engine 108 reaching the second engine speed (e.g., a minimum commanded speed), a predetermined amount of time after a clutch-engagement signal is sent (as discussed in greater detail below), or at a predetermined amount of time after the first engine speed signal was sent. In the latter case, for example, the predetermined amount of time can be selected to ensure that the engine is moving toward a speed (e.g., the third speed, as an operational speed, as discussed above) that can provide suitable torque capacity to power the compressor when it is coupled to the power source. As will be discussed below with respect to FIG. 4, there may be cases where an additional adjustment to the engine speed is made to obtain a final operational speed.

Still referring to FIG. 2, at block 212, the method 200 can include operating a clutch (or other coupling device) to move the clutch from a disengaged configuration to an engaged configuration. For example, as shown in FIGS. 3-5, the controller 180 (e.g., the clutch controller 184) can send an engagement signal 340 to the clutch 170 to initiate movement of the driven member 174 toward the drive member 172 (see FIG. 1), to move the clutch 170 from the disengaged configuration to the engaged configuration.

The method 200 can include commanding engagement by a clutch based on various operational parameters. In some implementations, a timing of a commanded engagement by a clutch can correspond to current engine speed, currently commanded engine speed, or predetermined time intervals between particular engine speed commands or other events. For example, where the clutch 170 is provided with an independent soft-start function (see FIG. 3), the controller 180 can send the engagement signal 340 at a predetermined time (e.g., approximately one second) after the engine 108 reaches a predetermined rotational speed (or another threshold, such as the second rotational speed). As another example, illustrated in FIG. 4, the controller 180 can send the engagement signal 340 when the engine 108 reaches a predetermined rotational speed moving from the first engine speed to the second engine speed, or a predetermined time prior to sending the second engine speed signal. In other implementations, including as shown in see FIG. 5, the controller 180 can send the engagement signal 340 at another time after sending a command to increase engine speed.

Generally, the time at which an engagement signal is sent by a controller can be selected to ensure that an engine (e.g., the engine 108) is at or above a minimum engagement speed when the clutch reaches the engaged configuration, to prevent the engine 108 from stalling due to the increased inertial load from the initial engagement with the compressor 120. More specifically, as clutch 170 couples the engine 108 to the compressor 120, the compressor will start compressing air, resulting in an inertial load that is applied to the engine 108. This inertial load can cause a temporary decrease in the speed of the engine 108 which can cause the engine 108 to stall if the rotating assembly of the engine 108 does not have enough power to overcome the inertial load of the compressor 120. For example, the speed of the engine 108 may need to be at or above 1000 RPM to avoid stalling when the clutch 170 is moved to the engaged configuration.

In some implementations, timing for clutch engagement can be determined to optimize a balance between the challenges of engaging a clutch during higher-speed rotation and the challenges of engine droop upon initial engagement. In some implementations, a clutch can be controlled so that the clutch reaches the engaged configuration after engine speed has begun a commanded increase in speed, but before the engine speed has substantially (or otherwise) increased relative to a starting (e.g., second or minimum) speed. In some implementations, for example, as shown in FIG. 3 by comparison between dot-dash line 302 and the local peak in engine speed after the clutch engagement signal 340 (i.e., actual clutch engagement), a clutch command can be timed so that the clutch reaches the engaged configuration before the engine speed exceeds the second speed by less than 25% of the difference between the second and third speeds (or between the second and first speeds, in some cases). Alternatively, as shown in FIG. 4 by comparison between dot-dash line 402 and the local peak in engine speed after the clutch engagement signal 340 (i.e., actual clutch engagement), a clutch command can be timed so that the clutch reaches the engaged configuration when the engine speed exceeds the second speed by greater than 25% of the difference between the second and third speeds (or between the second and first speeds, in some cases). Further, in some cases, a clutch command can be timed so that the clutch reaches the engaged configuration when the engine speed is within 25% of a fourth or final engine speed.

In some cases, when the compressor 120 is coupled to the engine 108, the air inlet valve 128 of the compressor 120 can be closed to further minimize the inertial load on the engine 108.

Accordingly, to provide flow to the supply line 104 as needed, at block 216, the controller 180 can be configured to open the air inlet valve 128 of the compressor 120. For example, in the illustrated embodiment, the controller 180 is configured to open the air inlet valve 128 once the clutch 170 has moved from the disengaged configuration to the engaged configuration and the engine 108 has recovered from any resultant dip in engine speed (see, e.g., inlet open signal 350 in FIGS. 3 and 4). In some implementations, for example, the air inlet valve 128 can be opened when the engine speed and compressor speed begin to increase together. In some implementations, the air inlet valve 128 can be opened when engine speed has increased substantially above a starting (e.g., minimum or second) speed but has not yet reached a target (e.g., third or operational) speed. For example, as shown with dot-dash line 304 in FIG. 3 and dot-dash line 402 in FIG. 4, an open command for the air inlet valve 128 can be timed so that the air inlet valve 128 opens after the engine speed differs from the third speed by less than 25% of the difference between the second and third speeds (or between the second and first speeds, in some cases), but while the engine speed is still below the third (e.g., operational) speed.

In different embodiments, a controller can be configured to command a power source to a third speed depending on various operational parameters. In different embodiments, a controller 180 can be configured to send an inlet open signal to the air inlet valve 128 based on various operational parameters. For example, as illustrated in FIGS. 3 and 4, where the clutch 170 includes a soft-engagement function, the controller 180 (e.g., the compressor controller 186) can be configured to command the air inlet valve 128 to open at least a threshold amount of time (e.g., one second) after the engine speed is commanded to increase to the third (e.g., operational) speed, after the engine 108 reaches a specific engine speed (e.g., approximately 1480 RPM in FIG. 3 or approximately 1980 RPM in FIG. 4), or before the engine 108 reaches a specific engine speed (e.g., the third speed). Thus, for example, although the loading associated with opening the air inlet valve 128 can cause another temporary dip in engine speed (see, e.g., FIG. 3), the engine may be able to quickly recover and proceed (or return) to a target (e.g., third) speed. In some cases, including where the clutch 170 does not include an independent soft-engagement function, as illustrated in FIG. 5, the controller 180 can be configured to send the inlet open signal at a predetermined time (e.g., at least one second) after an engagement signal is sent to the clutch 170, once the engine 108 reaches a specific engine speed (e.g., approximately 1475 RPM), or based on other parameters.

Where a third engine speed exceeds an operational speed or other desired final speed of an engine, the method 200 can further include reducing the engine speed to a fourth engine speed at block 218, For example, as illustrated in FIG. 4, the controller 180 can be further configured to send a third engine speed signal to command the engine 108 to reduce from the third engine speed to a fourth engine speed. As illustrated in FIG. 4, the fourth engine speed is the same as the first engine speed (e.g., 1500 RPM), however, it may also be greater than or less than the first engine speed (and generally between the second engine speed and the third engine speed).

In different embodiments, a controller can be configured to command a power source to a fourth speed depending on various operational parameters. For example, as illustrated in FIG. 4, the controller 180 can send a command signal 360 to the engine 108 to reduce from the third engine speed to the fourth engine speed at a predetermined time (e.g., greater than 0.5 seconds) after commanding an inlet valve to open. Accordingly, the inlet valve may open at the same time that the engine 108 is reducing from the third engine speed to the fourth engine speed. In other embodiments, however, other timings or criteria (e.g., pressure criteria) may be used.

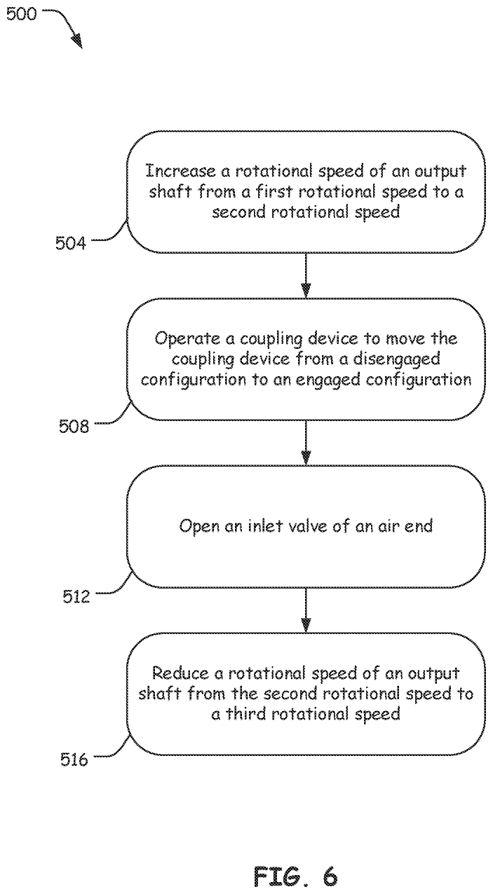

Referring now to FIG. 6, another method 500 is illustrated for operating the compressor system 100 to provide a soft-start function when engaging the engine 108 with the compressor 120, according to some aspects of the disclosure. The method 500 can be used with compressor systems having clutches with or without an independent soft-engagement functionality and may be particularly useful for engaging a clutch during a startup sequence for a compressor system (e.g., when starting an engine or compressor from a cold shut down state). While the method 500 is described with reference to the compressor system 100 discussed above, the method can also be used with other types of rotating machines. Additionally, operations of the method 500 need not be carried out in the specific order discussed below and, in some cases, may be implemented with other control devices and systems not explicitly described herein. Generally, the method 500 can be implemented using a variety of known general purpose control devices (e.g., the controller 180), or can be implemented using special-purpose control devices constructed according to known principles to implement the concepts disclosed herein.

At block 504, the method 500 can include increasing an engine speed from a first engine speed to a second engine speed, to increase a rotational speed of an output shaft from a first rotational speed to a second rotational speed. Generally, operations at block 204 can thus help to bring engine speed to a higher value so that engagement with a clutch does not reduce an engine speed below a minimum allowable engine speed, or so that that engagement of the clutch does not cause the engine speed to drop below another relevant threshold (e.g., the first engine speed). Accordingly, increasing engine speed at block 504 may be particularly useful when using a downsized engine, as increasing a rotational inertia of the engine can help to overcome an increased load resulting from engaging a clutch to operate a compressor. Correspondingly, by using startup procedures similar to those disclosed herein, compressor systems according to some embodiments can more reliably start up from cold, to provide service air, with substantially reduced engine sizes as compared to conventional systems.

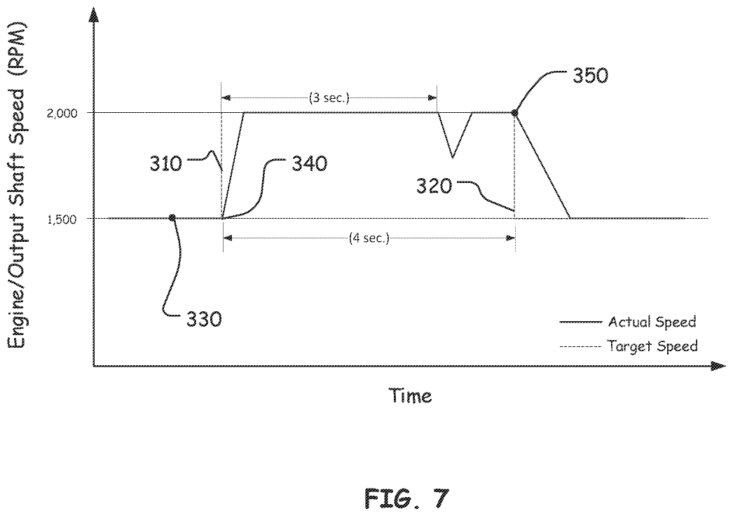

As one example, with additional reference to FIG. 7, at the start of the method 500 (i.e., at left in FIG. 7) the engine 108 may be controlled to operate at a first engine speed of approximately 1500 RPM, which may correspond with an operational speed of the engine 108. The controller 180 (e.g., the engine controller 182) may then provide a first engine speed signal 310 to increase the engine speed to a higher, second engine speed (e.g., approximately 2000 RPM or at least 20% above an operational speed). As shown in FIG. 7 and noted above, some embodiments can operate with a first engine speed that is equal to an operational speed for the engine (e.g., a low or high idle speed). In other embodiments, a first engine speed may be different than an operational speed for the engine (e.g., may be a lower startup speed).

In different embodiments, the controller 180 can be configured to command the power source 108 to the second speed depending on various operational parameters. For example, as similarly discussed above with respect to block 204, the controller 180 can be configured to command the engine 108 to increase from the first engine speed to the second engine speed once the engine 108 has increased to at least a minimum operating temperature or upon receiving a manual override signal. Thus, for example, the controller 180 may command an increase to the second speed at block 504 based on signals received from an internal or external temperature sensor, or based on an elapsed time corresponding to a predetermined warm-up interval.

Still referring to FIGS. 6 and 7, at block 508, the method 500 can include operating a clutch (e.g., the clutch 170) or another coupling device to move the coupling device from a disengaged configuration to be an engaged configuration once the engine 108 reaches the second engine speed. In some implementations, the controller 180 can send an engagement signal 340 based on one or more operational parameters. For example, as illustrated in FIG. 7, the engagement signal 340 can be sent at approximately the same time that the first engine speed signal 310 is sent, or otherwise generally before the engine 108 reaches the second engine speed. In other implementations, the engagement signal can be sent once the engine 108 reaches the second engine speed (e.g., for a clutch without an independent soft start functionality).

At block 512, and as similarly discussed above with respect to block 216, the controller 180 is configured to open the air inlet valve 128. In some embodiments, the controller 180 can open the air inlet valve 128 in response to the clutch 170 having moved from the disengaged configuration to the engaged configuration and a sensed recovery of the engine 108 from any resultant dip in engine speed (e.g., as indicated by signal 350 in FIG. 7). In some embodiments, the controller 180 can open the air inlet valve 128 at a predetermined amount of time (e.g., approximately 3 seconds) after the controller 180 sends the first engine speed signal or after the controller 180 commands clutch engagement.

At block 516, the controller 180 may provide the engine 108 with a second engine speed signal to decrease the engine speed to a lower, third engine speed (e.g., as indicated by command signal 320 in FIG. 7). In the example shown in FIG. 7, the third engine speed can be an operating speed of the engine 108 and, therefore, may be approximately the same as the first speed. In other implementations the third speed may be greater than or less than the first engine speed. In some embodiments, as similarly discussed above with respect to block 218, the controller 180 can be configured to send the second engine speed signal at a predetermined time (e.g., approximately 4 seconds after the controller sends the first engine speed signal, as shown in FIG. 7), including so that the inlet valve opens while the engine 108 is decreasing from the second engine speed to the third engine speed.

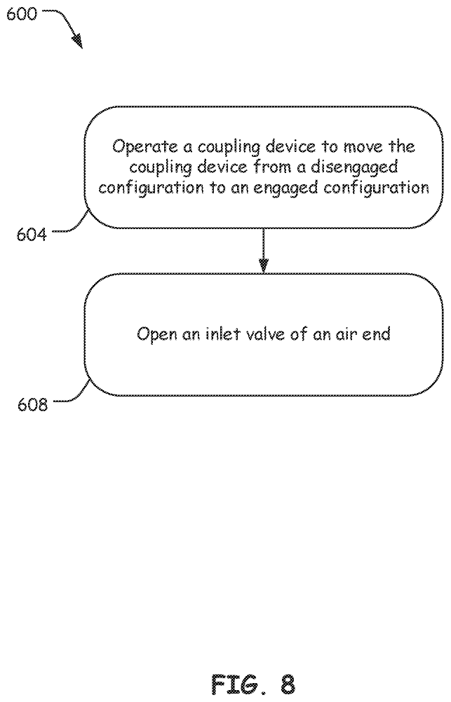

Referring now to FIG. 8, another method 600 is illustrated for operating the compressor system 100 to provide a soft-start function when engaging the engine 108 with the compressor 120, according to some aspects of the disclosure. The method 600 can be used with compressor systems having clutches with or without an independent soft-engagement functionality and may be particularly useful for engaging a clutch during a startup sequence for a compressor system (e.g., when starting an engine or compressor from a cold shut down state). While the method 600 is described with reference to the compressor system 100 discussed above, the method can also be used with other types of rotating machines. Additionally, operations of the method 600 need not be carried out in the specific order discussed below and, in some cases, may be implemented with other control devices and systems not explicitly described herein. Generally, the method 500 can be implemented using a variety of known general purpose control devices (e.g., the controller 180), or can be implemented using special-purpose control devices constructed according to known principles to implement the concepts disclosed herein.

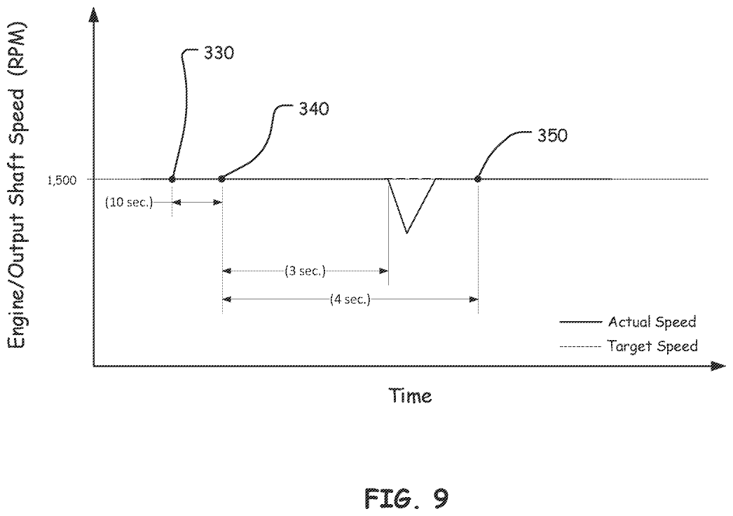

At block 604, and as illustrated in the example of FIG. 9, the method 600 can include operating a clutch (e.g., the clutch 170) or another coupling device to move the coupling device from a disengaged configuration to an engaged configuration once the engine 108 reaches a minimum operating temperature (e.g., when an engine coolant reaches a minimum threshold temperature, as indicated at time 330 in FIG. 9)), or another operational parameter satisfies a corresponding criterion (e.g., a run time or period of time after initializing a start-up sequence having exceeded a time threshold). Correspondingly, the controller 180 can be configured to send an engagement signal 340 based on the engine temperature or other operational parameter (e.g., as may indicate temperature indirectly).

At block 604, the engine 108 may be at a first engine speed that is sufficient to allow the clutch 170 to move from the disengaged configuration to the engaged configuration without causing the engine speed to reduce below a minimum allowable speed, or another relevant threshold value. For example, in some implementations, the engine 108 may be at a warm-up speed of approximately 1500 RPM Relatedly, the clutch 170 can include an independent soft-engagement functionality, but this is not required.

At block 608, and as similarly discussed above with respect to blocks 216 and 512, the controller 180 is configured to open the air inlet valve 128. In some embodiments, the controller 180 can open the air inlet valve 128 in response to the clutch 170 having moved from the disengaged configuration to the engaged configuration and a controller having sensed an appropriate (e.g., full) recovery of the engine 108 from any resultant dip in engine speed. In some embodiments, the controller 180 can open the air inlet valve 128 a predetermined amount of time (e.g., approximately 4 seconds, as indicated relative to command signal 350 in FIG. 9) after the controller 180 commands clutch engagement, as can similarly allow some amount of engine speed recovery before the inlet valve is opened.

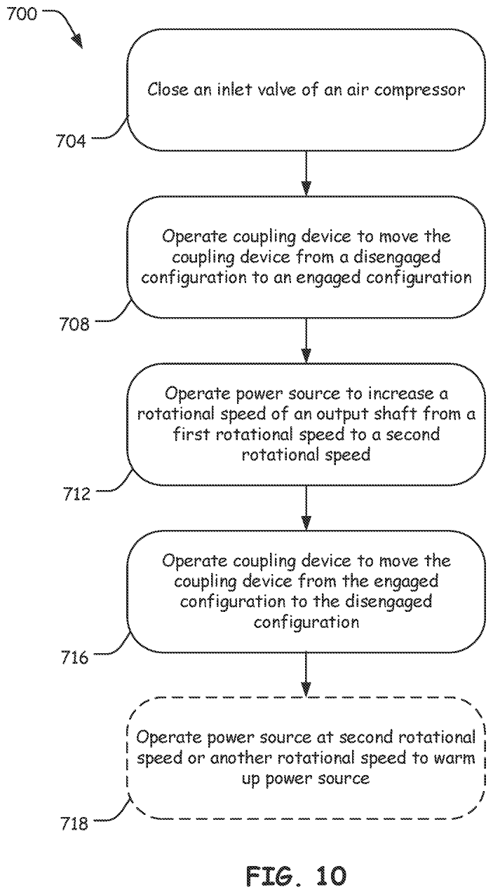

Referring now to FIG. 10, another method 700 is illustrated for operating the compressor system 100 to provide a priming function during a startup sequence (e.g., a starting strategy) to remove any existing, waxy oil within the compressor 120 (e.g., an oil film covering the screws of the compressor 120) and further reduce load on the engine 108, according to some aspects of the disclosure. That is, following a previous operation of the compressor system 100, the oil within the compressor 120 can become waxy (e.g., can increase in viscosity), particularly in cold environments, which increases the load applied to the engine 108. By removing this waxy oil from the compressor 120, the load imparted to the engine 108 by the compressor 120 during startup of the compressor 120 can be reduced.

The method 700 can be used with compressor systems having clutches with or without an independent soft-engagement functionality and may be particularly useful for engaging a clutch during a startup sequence for a compressor system (e.g., when starting an engine or compressor from a cold shut down state). While the method 700 is described with reference to the compressor system 100 discussed above, the method can also be used with other types of rotating machines. Additionally, operations of the method 700 need not be carried out in the specific order discussed below and, in some cases, may be implemented with other control devices and systems not explicitly described herein. Generally, the method 700 can be implemented using a variety of known general purpose control devices (e.g., the controller 180), or can be implemented using special-purpose control devices constructed according to known principles to implement the concepts disclosed herein.

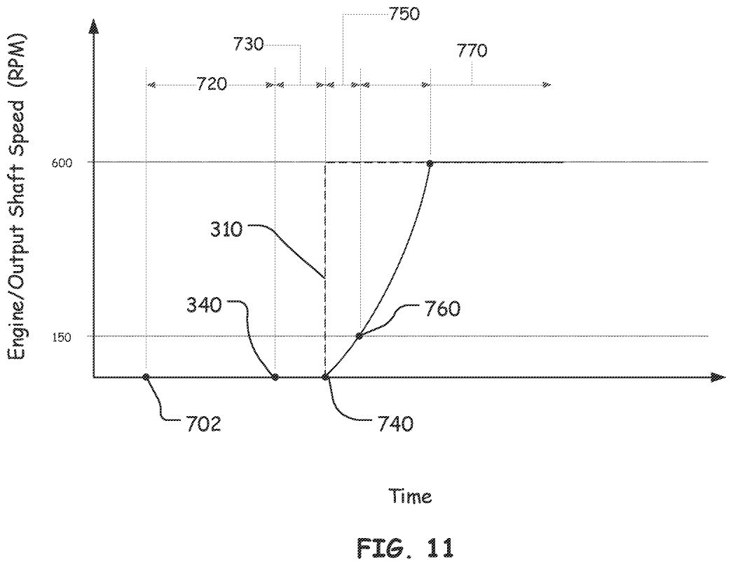

At block 704, the method 700 can include running an auxiliary compressor for the purpose of pressurizing a cavity that closes the inlet valve of the air compressor. For example, with additional reference to FIG. 11, in response to receiving a start-up signal (e.g., a key-on signal 702) and with the engine 108 in an “off” state so that the output shaft 112 is at a first rotational speed of 0 RPM, the controller 180 can be configured to close the air inlet valve 128 (see FIG. 1) to prevent air from entering or leaving the compressor system 100 (e.g., the compressor 120), thus minimizing a load on the engine 108 during start-up. More specifically, the controller 180 can be configured to operate an auxiliary compressor 192 (e.g., an electrically-powered compressor that receives power from the battery 110, see FIG. 1) to increase pressure at the inlet valve 128. The increase in pressure at the inlet valve 128 can cause the inlet valve 128 to close, which prevents air from entering the compressor 120 so that a vacuum can be formed within the compressor 120. This can help to minimize any parasitic load on the engine 108 during the start-up process by alleviating load associated with air compression. In that regard, the controller 180 can be configured to run the auxiliary compressor 192 (e.g., over interval 720) until the compressor system 100 reaches a predetermined minimum threshold pressure (e.g., approximately 55 psi) at the inlet valve 128, at which point the pressure causes the inlet valve 128 to close. In some cases, the controller 180 can be configured to run the auxiliary compressor 192 for predetermined period of time (e.g., approximately 10 seconds). The specific period of time may be selected to achieve a desired minimum threshold pressure within the compressor system 100 and therefore may vary depending on the flow rate of the auxiliary compressor 192, the volume to be pressurized, and the desired minimum threshold pressure.

At block 708, the method 700 can include operating a clutch (e.g., the clutch 170) or another coupling device to move the coupling device from a disengaged configuration to an engaged configuration. For example, the controller 180 can be configured to send an engagement signal 340 to clutch 170 once the compressor system 100 is at or above the minimum threshold pressure at the inlet valve 128 (e.g., at the end of the interval 720), thereby operatively coupling output shaft 112 of the engine 108 to the compressor 120. The engagement signal 340 can be sent automatically upon reaching the minimum threshold pressure or based on other criteria, or manually by an operator (e.g., via a button press). However, as also generally discussed above, actual clutch engagement may not occur for an interval 730 thereafter, due to inherent (or other) delays between the commanded and actual clutch engagement.

At block 712, the method 700 can including operating (e.g., starting) a power source (e.g., the engine 108) to increase a rotational speed of an output shaft from a first rotational speed of 0 RPM to a second rotational speed. For example, with the clutch 170 in the engaged configuration, the controller 180 can be configured to start the engine 108 by commanding a starting motor 194 to engage the engine 108 and increase the speed of the output shaft 112 from 0 RPM to a non-zero rotational speed (e.g., approximately 600 RPM). Correspondingly, starting the engine 108 can include the controller 180 sending a first engine speed signal 310 to the engine to increase the speed of the output shaft 112 to the second rotational speed. Operations at block 712 may commence once the clutch 170 is fully-engaged, or after a predetermined amount of time (e.g., approximately 4 seconds) following the engagement signal at block 708. Consequently, as the starter motor 194 increases the speed the engine 108, and thus the output shaft 112, the compressor 120 will increase in rotational speed with the output shaft 112 over a time interval 750. Put another way, the output shaft 112 provides operational power to increase rotational speed of the compressor 120.

At block 716, the method 700 can include operating a clutch (e.g., the clutch 170) or another coupling device to move the coupling device from an engaged configuration to a disengaged configuration, including after (e.g., immediately after) operations under block 712. For example, the controller 180 can be configured to send a disengagement signal 760 to the clutch 170 to move the clutch 170 from the engaged configuration to the disengaged configuration, thereby decoupling the compressor 120 from the output shaft 112. As illustrated in FIG. 11, operations at block 716 can commence corresponding to the output shaft 112 increasing to the second rotational speed.

More specifically, the controller 180 can be configured to send the disengagement signal 760 once the output shaft 112 reaches a predetermined rotational speed (e.g. 150 RPM) or after a predetermined period of time of power source operation according to block 712 (i.e., with the clutch engaged and the power source operating, over the interval 750). Further, the predetermined rotational speed or predetermined period of time can be selected so that the compressor 120 completes a minimum number of rotations sufficient to remove substantially all of the waxy oil from the compressor 120 before the clutch is disengaged (and power is thus removed from the compressor). In some cases, the compressor 120 can rotate to complete at least two revolutions to remove any waxy oil from the compressor 120 (with an associated minimum length of time for clutch engagement corresponding to at least two revolutions for a particular engine speed or speeds).

Because the output shaft 112 is thus decoupled from the compressor 120, the output shaft 112 will continue to increase in speed to the second rotational speed, independently of the compressor. Accordingly, at block 718, after temporary operation to remove oil from the compressor, the engine 108 can continue operating to warm up the engine 108 during startup (e.g., at the second rotational speed, or another rotational speed), without the added load of the compressor 120 (e.g., over time interval 770 in FIG. 11). Subsequently, after appropriate engine warm-up or other period of operation, the compressor 120 can be re-engaged with the engine 108 (e.g., using any of the previously described approaches for operation of a coupling device).

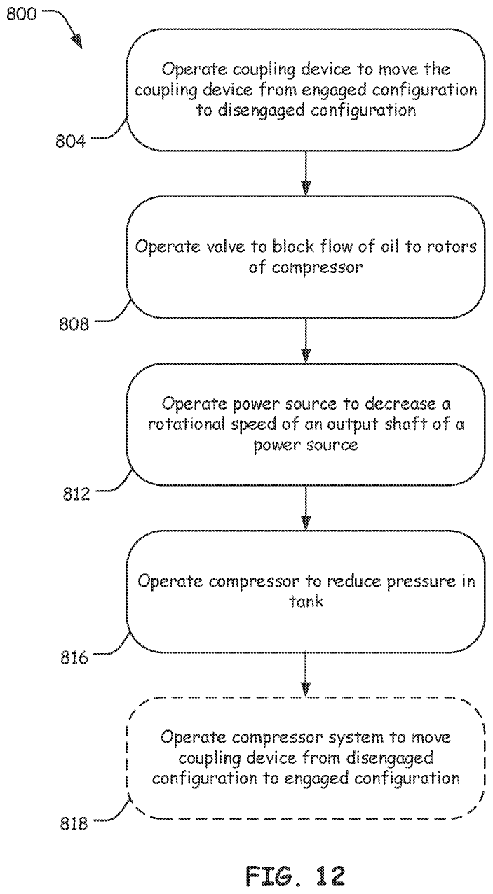

Referring now to FIG. 12, another method 800 is illustrated for operating the compressor system 100, including for operation in a disengaged mode after a startup sequence or otherwise. For example, following a previous operation of the compressor system 100 in an engaged mode (e.g., with a clutch engaged after associated patterns of engine speed and other commands, as discussed regarding any of the methods above), it may be useful to disengage a clutch during periods of reduced (e.g., zero) demand for compressed air. This approach, for example, may provide for notable reduction in fuel consumption when service air is not needed, without requiring an engine to be stopped and then restarted.

The method 800 can be used with compressor systems having clutches with or without an independent soft-engagement functionality. While the method 800 is described with reference to the compressor system 100 discussed above, the method can also be used with other types of rotating machines. Additionally, operations of the method 800 need not be carried out in the specific order discussed below and, in some cases, may be implemented with other control devices and systems not explicitly described herein. Generally, the method 800 can be implemented using a variety of known general purpose control devices (e.g., the controller 180), or can be implemented using special-purpose control devices constructed according to known principles to implement the concepts disclosed herein.

At block 804, the method 800 can include operating a clutch (e.g., the clutch 170) or another coupling device to move the coupling device from an engaged configuration to a disengaged configuration. Thus, although the relevant power source (e.g., engine 108) may continue to operate, the power source may not be loaded by an operational coupling to the compressor. In some examples, the controller 180 can be configured to send a disengagement signal to clutch 170 in response to an operator input (e.g., a button push to start operation in a disengaged mode). In other examples, other inputs or conditions can result in automatic (or other) disengagement of a coupling device.

At block 808, typically after the coupling device is disengaged at block 804, a valve can be closed to prevent pressurized air in a tank of the compressor system from pushing oil into the rotors of the compressor. For example, referring to FIG. 1, a valve 196 can be controlled to block flow of oil into an oil injection port of the compressor 120. The valve 196 is represented schematically in FIG. 1, but can be an electronically controlled solenoid valve in some cases, or can be other types of controllable valves. Further, those of skill in art will recognize that such a valve can be arranged at other locations with similar effect. In some examples, a valve can be commanded to close to prevent oil flow into the compressor simultaneously with or substantially simultaneously with (i.e., within 0.25 seconds of) a signal to disengage a clutch.

Other valves can also operate to prevent oil from flowing into the compressor in a disengaged mode, including check valves of various generally known configurations (not shown) that can be arranged between the separator tank 132 and a discharge port of the compressor 120. Thus, for example, during implementation of the method 800, oil can be prevented from accumulating in the compressor 120, thereby avoiding any corresponding increase in the power required to restart the compressor 120 upon reengagement of the clutch 170 (i.e., upon exit from the disengaged mode).

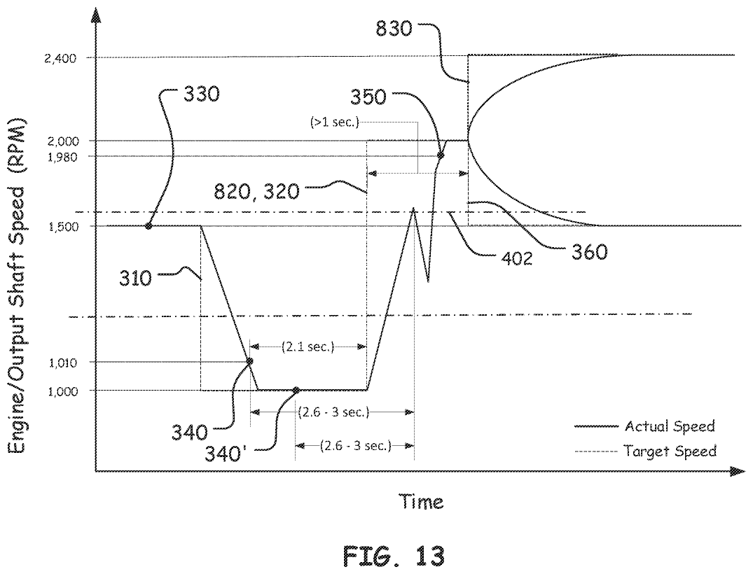

At block 812, with the coupling device disengaged (e.g., at block 804), the method 800 can include decreasing the rotational speed of the power source. For example, as shown in FIG. 13, the engine 108 may receive a first engine speed (change) command signal 310 from the controller 180 (e.g., the engine controller 182) to reduce the engine speed to a lower (e.g., second or fourth) engine speed that is, for example, between 500 RPM and 1,200 RPM. In some examples, the decreased speed of the power source can be the same as a decreased speed under various methods discussed above (e.g., 1,000 RPM). For example, the engine 108 may be operating at a first (or third) speed of 1,500 RPM according to the sequences illustrated in FIG. 3, 4, 5, 7 or 9, and the command signal 310 (or other signal) can then reduce the engine speed to a second (or fourth) speed of 1,000 RPM.

In addition, the method 800 can include, at block 816, operating the compressor system to reduce pressure within a tank arranged to receive pressurized air from the compressor. For example, one or more additional valves (not shown) can be operated according to various known approaches to lower pressure within the separate tank 132. Thus, in some examples, when the clutch 170 is re-engaged with the compressor 120, the compressor 120 may see a relatively low back pressure from the separator tank 132 and the initial load on the engine 108 can be correspondingly low. In some examples, tank pressure can be lowered to an intermediate non-zero value (e.g., 50 psi), which can allow for more rapid re-pressurization in response to demand for service air. In some examples, tank pressure can be lowered to zero psi (e.g., for operation in a disengaged mode for longer periods).

After operating for a time in the disengaged mode, the method 800 can include operating the compressor system to move into an engaged mode of operation. In some examples, transition to an engaged mode can be triggered by an operator input (e.g., another button push) or can be implemented automatically based on detection of increased demand for pressurized air (e.g., via monitoring of pressure between the separator tank 132 and the supply line 104). Correspondingly, at block 818, the compressor system can be operated move a coupling device (e.g., the clutch 170) to an engaged configuration, so that the compressor can be powered by the power source. In this regard, any valves that may have been operated to block flow of oil to the compressor (e.g., at block 808) can be operated to allow flow of oil to the rotors, so that the compressor can function appropriately once it is again powered by the power source. For example, as part of transitioning from a disengaged mode to an engaged mode, the valve 196 (see FIG. 1) can be re-opened so that oil can again flow to the rotors of the compressor 120.

Generally, engagement (or re-engagement) of a clutch to exit a disengaged mode can proceed as discussed above, including relative to engine and clutch signals 320, 340 as shown in FIGS. 13 and detailed relative to FIG. 4 (and other figures). However, in some examples, a compressor system may operate for an extended time at a reduced engine speed (e.g., at 1,000 RPM) and thus a clutch engagement signal may be provided while the compressor system is operating at that reduced speed. Thus, for example, a clutch engagement signal 340′ may in some cases be provided while the engine is at a steady-state lower speed rather than as the engine is decreasing to that lower speed. Generally, in this regard, it may be useful to provide the clutch engagement signal 340 (or 340′) a predetermined duration of time before the engine speed command signal 320 so that the clutch 170 does not actually engage until engine speed has been sufficiently increased (e.g., expecting a time of 2.6 to 3 seconds between engagement command and actual clutch engagement, as shown in FIG. 13).

In some examples, a valve for oil flow to a compressor can be commanded to open simultaneously with or substantially simultaneously with (i.e., within 0.25 seconds of) a command to increase engine speed for re-engagement of a coupling device. For example, as shown in FIG. 13, a valve opening signal 820 can be provided simultaneously with the engine speed signal 320 (and, e.g., after the clutch engagement signal 340, 340′) so that the compressor 120 is adequately supplied with flow of oil when the compressor again begins to be powered by the engine 108. In other examples, however, other timings are possible for each of the discussed command signals. For example, if a pressure of a tank is significantly reduced during operation in a disengaged mode (e.g., reduced to 0 psi), a valve for oil flow may be opened earlier, because pressure in the tank may take longer to build to a level at which oil may begin to flow to the compressor.

In some examples, as also discussed above relative to FIG. 4, once an engine speed has stabilized at an increased speed (e.g., after the inlet vale is opened by the inlet open signal 350), engine speed can be reduced to an idle (or other) speed. In some examples, engine speed can instead be increased (e.g., with a command signal 830) to a working speed (e.g., 2,400 RPM as shown in FIG. 13).

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Additionally, as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

We claim:

1. A compressor system, comprising:
a power source;
a compressor;
a coupling device disposed between the power source and the compressor to selectively couple the power source to the compressor; and
a control device configured to move the coupling device between a disengaged configuration, in which the power source is decoupled from the compressor, and an engaged configuration, in which the power source is coupled to the compressor via the coupling device.

2. The compressor system of claim 1, wherein, the control device is configured to move the coupling device from the disengaged configuration to the engaged configuration during a startup sequence for the compressor system, after the control device increases a speed of the power source from a startup speed to a minimum engagement speed.

3. The compressor system of claim 2, wherein the control device is configured to reduce the speed of the power source from the minimum engagement speed to an operational speed after the coupling device reaches the engaged configuration, to provide service air with the compressor.

4. The compressor system of claim 1, wherein, the control device is configured to move the coupling device from the disengaged configuration to the engaged configuration during a startup sequence for the compressor system in response to an engine coolant exceeding a minimum threshold temperature.

5. The compressor system of claim 1, wherein, the control device is configured to move the coupling device from the disengaged configuration to the engaged configuration after the control device reduces a speed of the power source from a first speed to a second speed; and
wherein the control device is configured to move the coupling device from the disengaged configuration to the engaged configuration as the control device increases the speed of the power source from the second speed to a third speed.

6. The compressor system of claim 5, wherein the control device is configured to provide an engagement signal to the coupling device after reducing the speed of the power source to the second speed and before increasing the speed of the power source to the third speed, to cause the coupling device to be moved to the engaged configuration after the control device increases the speed of the power source from the second speed.

7. The compressor system of claim 5, wherein the control device is further configured to open an inlet valve of the compressor as the speed of the power source moves from the second speed to the third speed.

8. The compressor system of claim 1, wherein control device is configured to maintain the coupling device in the disengaged configuration during a start-up sequence for the power source, and to move the coupling device from the disengaged configuration to the engaged configuration in response to the power source reaching a minimum operating temperature.

9. The compressor system of claim 1, wherein the power source is an internal combustion engine.

10. The compressor system of claim 1, wherein the coupling device is an electromagnetic clutch.

11. A method of operating a compressor system, the method comprising:
with one or more electronic control devices, decreasing a speed of a power source from a first speed to a second speed when a coupling device is in a disengaged configuration that decouples the power source from a compressor;
with the one or more electronic control devices, after decreasing the speed of the power source to the second speed, increasing the speed of the power source from the second speed to a third speed; and
with the one or more electronic control devices, controlling the coupling device to move from the disengaged configuration to an engaged configuration, as the speed of the power source increases from the second speed, to couple the power source to the compressor so that an output shaft of the power source rotates an input shaft of the compressor.

12. The method of claim 11, wherein the coupling device is controlled to reach the engaged configuration when the speed of the power source exceeds the second speed by less than 25% of a difference between the third speed and the second speed.

13. The method of claim 12, further comprising:
with the one or more electronic control devices, as the speed of the power source increases from the second speed, after the coupling device reaches the engaged configuration, and before the speed of the power source reaches the third speed, opening an inlet valve of the compressor.

14. The method of claim 13, wherein the inlet valve is controlled to open when the speed of the power source differs from third speed by less than 25% of the difference between the third speed and the second speed.

15. The method of claim 11, further comprising, after controlling the coupling device to move from the disengaged configuration to the engaged configuration, controlling the compressor system to operate in a disengaged mode, including, with the one or more electronic control devices:
controlling the coupling device to move from the engaged configuration to the disengaged configuration;
closing a first valve to block flow of oil to rotors of the compressor;
decreasing the speed of the power source to a fourth speed; and
reducing a pressure of a tank that is arranged to receive pressurized air from the rotors.

16. The method of claim 15, wherein the fourth speed is equal to the second speed.

17. The method of claim 15, further comprising, with the one or more electronic control devices, after operating in the disengaged mode:
opening the first valve to allow flow of oil to the rotors;
increasing the speed of the power source to a fifth speed; and
controlling the coupling device to move from the disengaged configuration to an engaged configuration, as the speed of the power source increases to the fifth speed, to re-couple the power source to the compressor so that the output shaft of the power source rotates the input shaft of the compressor.

18. The method of claim 17, wherein the fifth speed is equal to the third speed.

19. A method of starting a compressor system, the method comprising, in a start-up sequence for the compressor system:
with a power source at a first rotational speed, controlling a coupling device to operationally couple the power source to a compressor;
with the coupling device operationally coupled to the power source, increasing a rotational speed of the power source from the first rotational speed to a second rotational speed to cause powered rotation of the compressor; and
with the compressor in powered rotation:
controlling the coupling device to decouple the power source from the compressor; and
further increasing the rotational speed of the power source toward an operational speed.

20. The method of claim 19, wherein the coupling device is controlled to decouple the power source from the compressor after at least one of:
the compressor completes a predetermined number of rotations;
a predetermined amount of time; or
an output of the power source to the coupling device reaches a predetermined speed.

21. The method of claim 20, further comprising:
before controlling the coupling device to couple the power source to the compressor, closing an air inlet valve of the compressor.
